(19) United States
(12) Patent Application Publication
(10) Pub. No.: US 2022/0327562 A1
(43) Pub. Date: Oct. 13, 2022

(54) METHODS AND SYSTEMS FOR APPLYING SURVIVAL ANALYSIS MODELS TO PRODUCE TEMPORAL MEASURES OF SALES PRODUCTIVITY

(71) Applicant: Funnelcast LLC, Wayland, MA (US)

(72) Inventors: William Kantor, Wayland, MA (US); Bryan Wayne Lewis, Friendsville, MD (US)

(21) Appl. No.: 17/714,038

(22) Filed: Apr. 5, 2022

Related U.S. Application Data
(60) Provisional application No. 63/170,882, filed on Apr. 5, 2021.

(51) Int. Cl. G06Q 30/02; G06Q 10/06

(52) U.S. Cl. CPC G06Q 30/0202; G06Q 30/0201; G06Q 10/067; G06Q 10/06315

(57) ABSTRACT

Methods and systems of fitting survival models to customer relationship management (CRM) data are presented. The models are used to compare productivity across business cohorts, optimize business sales processes, better plan for resource usage, and forecast events. Input to the systems include external CRM data along with other relevant business data, which are stored in a time-series database for processing.

### FIELD OF THE INVENTION

The present invention relates generally to methods and systems for producing comparisons of business cohort productivity, optimization of business processes, resource planning, and forecasting.

The methods and systems disclosed herein describe particular embodiments that employ survival analyses and related statistical methods to fit models to processed data from business customer relationship management (CRM) systems. The models are used to produce the comparisons of business cohort productivity, for optimization of business sales processes, and for resource planning and sales or other event forecasting. The embodiments are not intended to be exhaustive of the contemplated applications and business processes.

### BACKGROUND OF THE INVENTION

Producing measures of sales productivity for comparative purposes generally involves the evaluation of aggregated sales results by business cohort over business calendar intervals. Sales forecasts are typically defined by aggregating manually estimated probabilities of closing and closing dates for each sales opportunity in the current sales pipeline plus an estimate of new business in the interval.

This typical approach generally provides a reasonable, but coarse, approximation of the actual sales process. Because manual probability and closing estimates assigned to a specific sales opportunity are usually only precise when that opportunity nears closing, aggregate medium and long-term forecasts and comparisons based on this approach are generally not very accurate.

The modern availability of detailed customer relationship management telemetry data allows the development of more sophisticated modeling approaches to the development of sales forecasts. Each step in the sales process of every sales opportunity recorded in such systems includes detailed descriptions of changes in the sales pipeline stage, estimated closing date, sales contact activity, and many other features.

In light of the availability of detailed customer relationship management telemetry data and the foregoing and other problems associated with traditional sales forecasting and productivity measurement, there is a need for improved methods and systems for producing temporal measures of sales productivity based on CRM and business organization data that may overcome one or more of the above-mentioned problems and/or limitations.

CRM data is a common method of record-keeping for a variety of businesses that essentially stores a series of records for each opportunity along with other data. A record may include customer name, details, interaction dates and any other data associated with the business.

Survival analysis is a field of statistics for modeling the time to an event occurrence for a population or cohort. Examples include models of time to failure in reliability engineering, or time to death in the epidemiology and actuarial sciences.

### SUMMARY OF THE INVENTION

The present invention comprises methods and systems of using survival models applied to CRM data for comparisons of business cohort productivity, optimization of business processes, resource planning, and forecasting. Sales process CRM data include various business cohort definitions, sales process stages, sales opportunity record creation and modification dates, and other data that may be used by survival models.

Additional details are provided in CRM data that further describe the nature of each opportunity such as business cohorts like region, customer size, product, lead source, and opportunity type.

CRM data are processed to include time to event data for subsequent survival model fitting.

Models fit to business cohort, stage, and staleness groups can be used to infer differences between groups by comparing event probabilities over time across groups; or applied to open opportunity records to produce forecasts of events occurring. Models fit to business cohorts for new opportunities (according to the method of FIG. 2) can be used to infer differences between cohorts or combined with time-series models to produce forecasts of new opportunity events. Optionally, forecasts may be weighted by anticipated sales price to create forecasts of expected sales value.

### BRIEF DESCRIPTION OF THE DRAWINGS

FIG. 1 is a flow diagram showing an overview of the survival model generation method in the present invention.

FIG. 2 is a flow diagram showing the method for fitting cumulative incidence curves to new opportunities.

FIGS. 3 and 4 comprise flow diagrams showing the method for fitting cumulative incidence curves to open opportunity records.

FIG. 5 is a flow diagram showing how cumulative incidence curves are used to produce a forecast for an individual open opportunity record.

FIG. 6 is a flow diagram showing the forecasting process for new opportunities across business cohorts.

FIG. 7 is a flow diagram showing the forecasting process for all open opportunity records.

FIG. 8 shows four example cumulative incidence curves. The four illustrated curves could represent different business cohorts for new opportunities; or sales stages, or a combination of sales stages, business cohorts, and staleness for open opportunities.

FIG. 9 shows a system described by the present invention in which a user provides customer relationship management data and receives calculated output.

### DETAILED DESCRIPTION OF THE INVENTION

The preferred embodiment of the invention is described herein, and language in the description should not be construed to limit the multiple embodiments of the invention enabled by the claims.

### I. Definitions

As used in this specification and the appended claims:
1. The term “opportunity” refers to a subset of CRM data associated with a common potential event.
2. The term “opportunity record” refers to a subset of raw customer relationship data used to calculate a time to event, whether the event did occur (event=1) or did not occur (event=0), stage, business cohort, and staleness.
3. The term “open opportunity record” means the most current entry associated with one of a plurality of all non-event opportunities.
4. The term “stage” refers to any labeled step of the sales process.
5. The term “event” refers to the first transition of an opportunity to a defined stage or one of a set of stages. Typically the term event refers to a sale, but events can refer to any specified opportunity stage or group of stages.
6. The term “business cohort” refers to any partition of the CRM opportunities for the purpose of comparison.
7. The term “staleness” refers to, for each stage, a partition of observed times from first entry into that stage.
8. The term “time to event” refers to the time from an opportunity entry into a (business cohort, stage, staleness) class until either a fixed endpoint in time (event=0) or until the opportunity transitions to an event (event=1), whichever is less.

### II. Description of Methods of Applying Survival Analysis Models to Customer Relationship Management Sales Data

Drawings are included for the purpose of describing selected versions of the present invention and are not intended to limit the scope of the present invention.

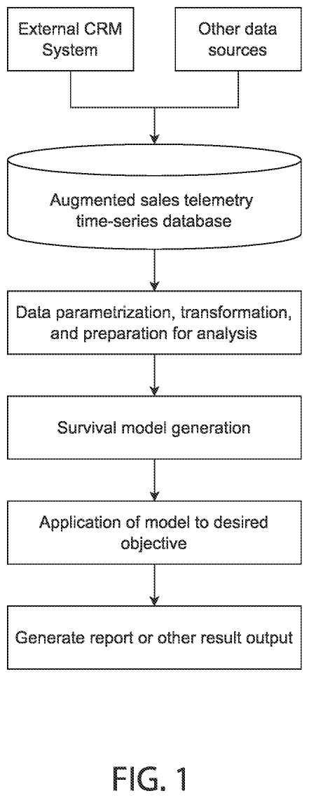

FIG. 1 details the workflow of the preferred embodiment of the present invention. First, a plurality of raw data is primarily gathered from a client's customer relationship management (CRM) system. This raw data may also include other relevant data disclosed from the client. The plurality of raw data is then uploaded to a time-series database.

The present invention may use many forms and embodiments of a time-series database. Generally, the time-series database will contain rows of records that keep track of time and other relevant customer data, so that the data may be stored securely and processed efficiently.

The raw data is then prepared for analysis by assigning parameters such as business cohort, stage, staleness for each opportunity, whether each sales opportunity transitions to an event, and time to event. This data processing occurs by transforming parameters defined in raw data and completing simple operations such as computing time to event and staleness.

Table I shows some example opportunity records comprising raw CRM data.

TABLE I

| | | | | | |
|---|---|---|---|---|---|
| | | | Created | Modified | Other |
| ID | Stage | Geo | date/time | date/time | fields . . . |

| | | | | |
|---|---|---|---|---|
| A | First call | East Asia | Jan. 15, 2022 5pm | Jan. 15, 2022 5pm |
| A | Negotiation | East Asia | Jan. 15, 2022 5pm | Feb. 15, 2022 3pm |
| B | First call | Europe | Aug. 12, 2021 11am | Aug. 12, 2021 11am |

Sales opportunities may be further broken into subsets for analysis based on business cohort, stage, and staleness. Notably, staleness is a set of quantiles for a given cohort and stage calculated from the observed times from first entry into that stage. The use of staleness quantiles introduces the flexibility of additional models of fine-grained behavioral change as an opportunity sits around in a stage.

Next a survival model is generated for each subset of parameters: stage, business cohort, and staleness quantile. Based on the objectives of the client, the survival model is then applied to the plurality of opportunity records to produce a cumulative incidence curve for each subset of parameters showing the chances of an event over time. The cumulative incidence curves are applied to existing opportunities to produce sales forecasts of existing opportunities, which can be used to compare business cohorts, optimize business productivity, and better plan for resource usage. Related cumulative incidence curves based on the business cohort are developed for “new opportunities,” to predict future sales and allow for a complete understanding of future sales based on both existing and new opportunities that do not currently exist.

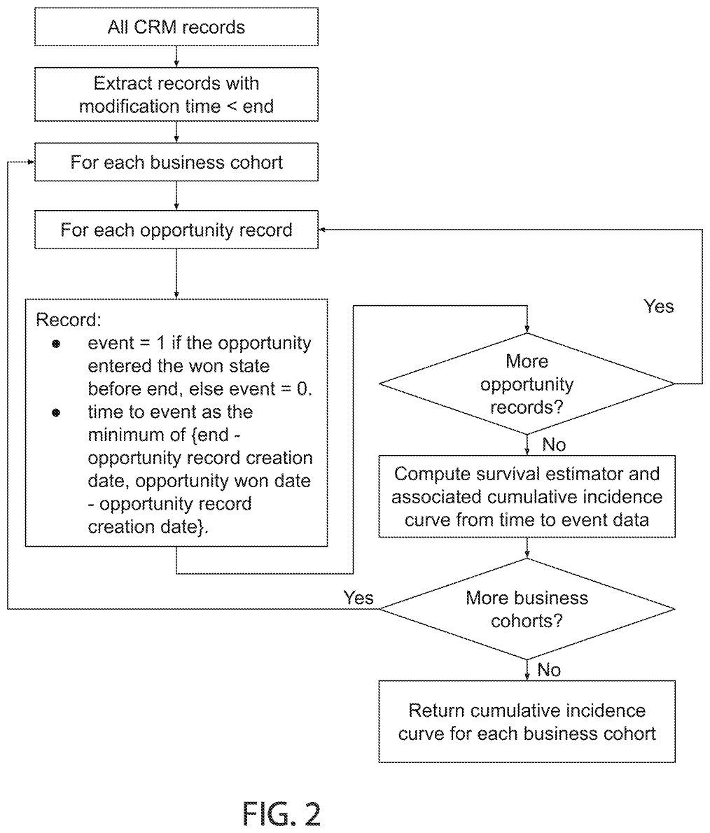

FIG. 2 illustrates the new opportunity cumulative incidence curve fitting process. The process produces, for each filtered opportunity record within each business cohort, an event (1 or 0) and associated time to event. Analysis by the Kaplan-Meier estimator, Cox proportional hazards, or related survival model estimation method produces a cumulative incidence curve for each business cohort. The curves represent the probability of an event occurring over time for each business cohort.

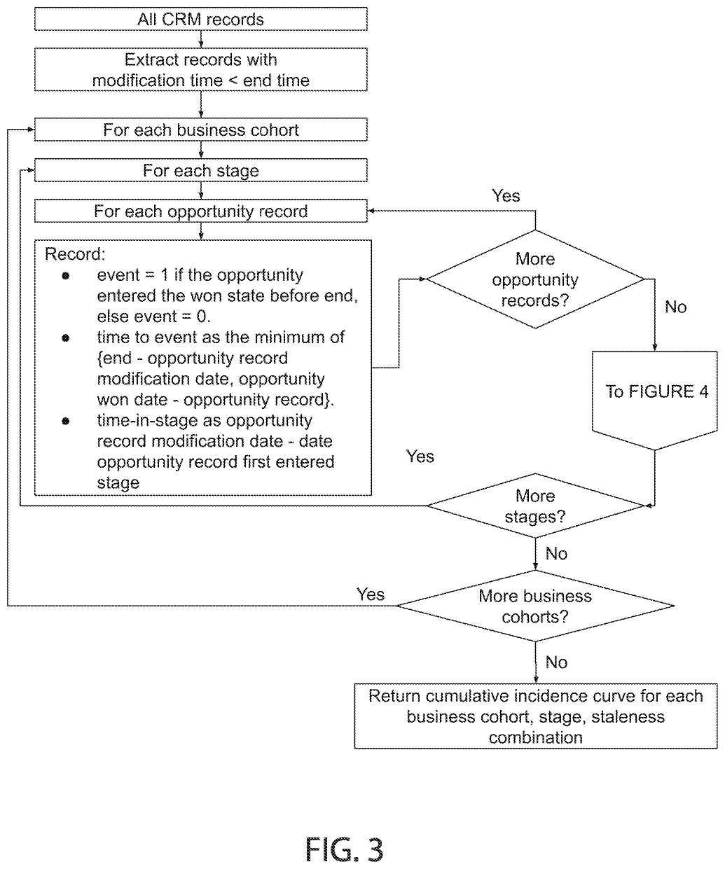

FIGS. 3A and 3B illustrate fitting survival models and associated cumulative incidence curves to open opportunity records. The procedure, for open opportunity records with defined business cohort and stage, identifies staleness quantiles and fits survival models and associated cumulative incidence curves to each group of open opportunity records partitioned by business cohort, stage, and staleness quantile. The process produces a total of N×S models and associated cumulative incidence curves for each staleness quantile, where N is the number of business cohorts and S the number of stages.

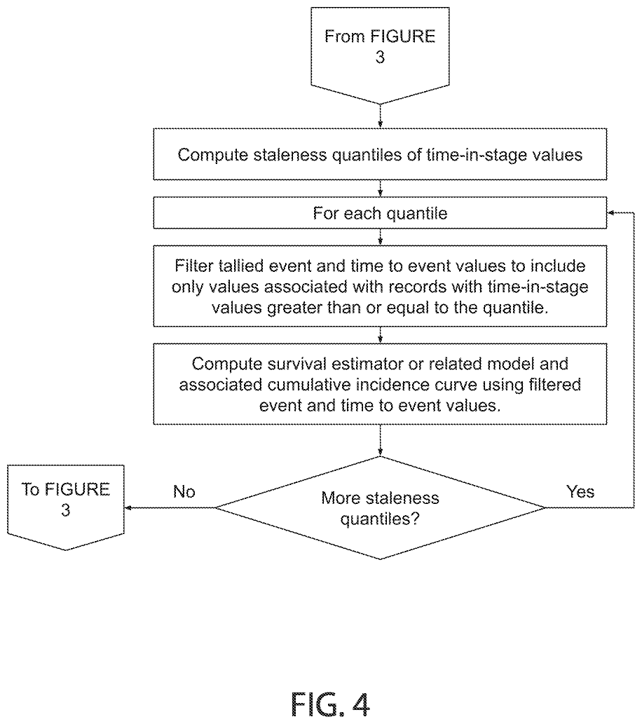

FIG. 4 illustrates production of a forecast prediction for a single open opportunity record. The forecast is a cumulative incidence curve fit by the method of FIGS. 3A and 3B that represents the probability of an event occurring over time for the open opportunity record. The forecast may be weighted by the open opportunity anticipated sales price to estimate expected value of the open opportunity over time.

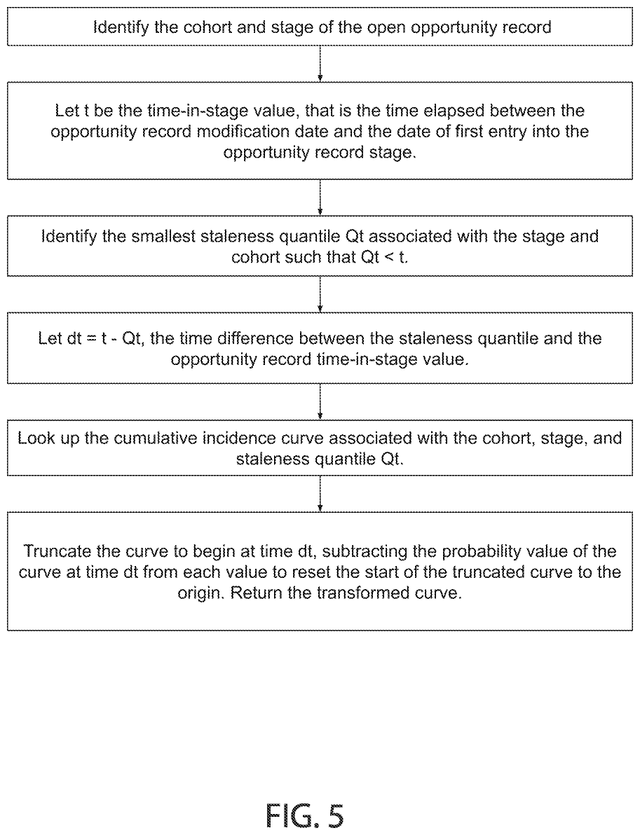

FIG. 5 illustrates production of a forecast prediction for all new opportunities generated according to the described time-series model for each business cohort. The forecasts represent the expected number of new opportunity events occurring over time for each business cohort. The forecasts may be weighted by the average sales prices by respective business cohort to estimate expected value of new opportunities generated over time for each cohort.

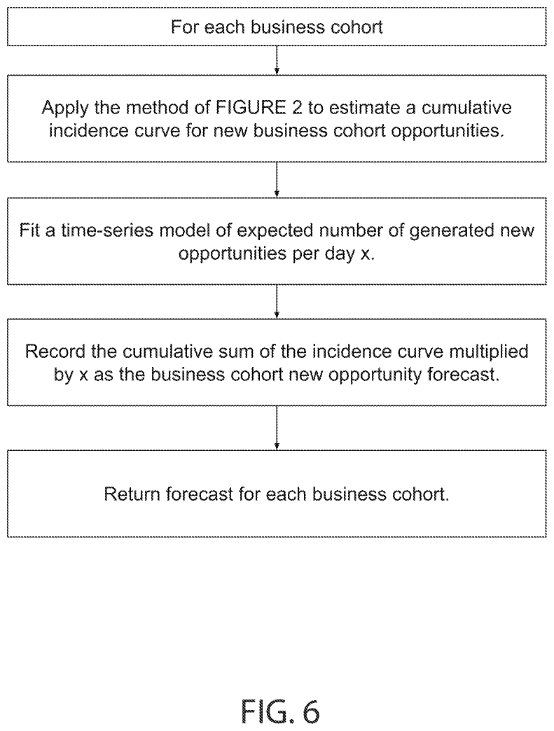

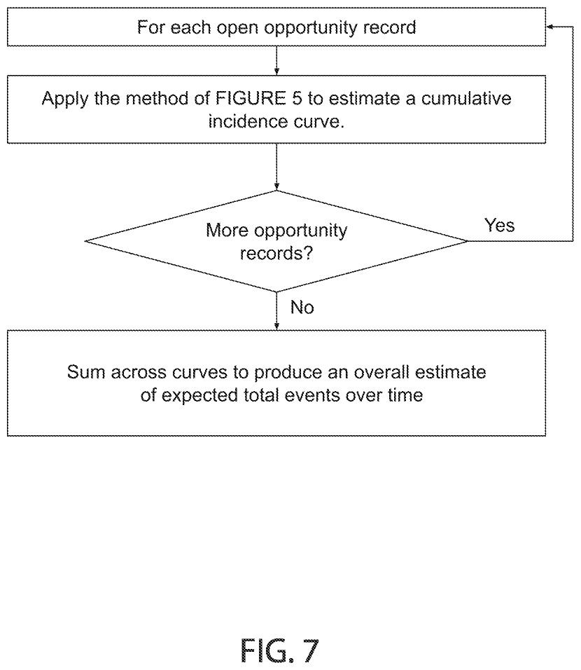

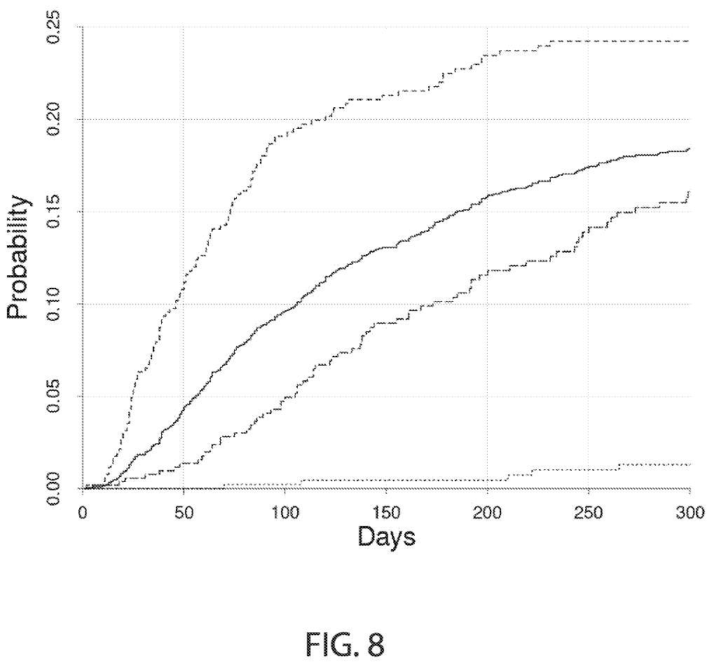

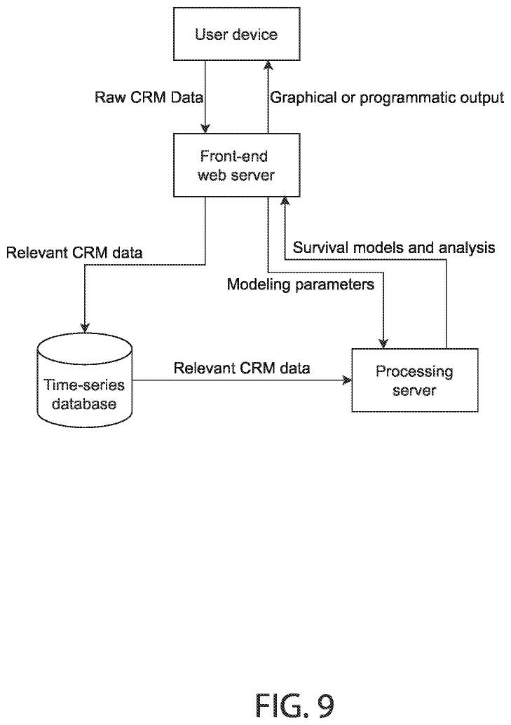

FIG. 6 illustrates production of a forecast prediction for all open opportunity records using the method of FIGS. 3A and 3B applied to each open opportunity record. The forecast represents the expected number of open opportunity record events occurring over time. The forecast may be weighted by each open opportunity's anticipated sales price to estimate the expected value of all open opportunities over time.

Given an overall forecast of the open opportunity records and a goal for desired sales objective in a defined period of time, the new opportunity models computed according to FIG. 2 can be used to solve for the new opportunity generation required to achieve the goal for desired sales in a defined period of time. Further various defined constraints may be provided per business cohort to solve for optimal business cohort combinations to meet desired sales objectives.

### III. Description of Systems for Applying Survival Analysis Models to Customer Relationship Management Sales Data

The present invention further includes systems for inputting customer relationship data and viewing cumulative incidence curves and sales forecasts.

The system comprises a user input component comprising a web server, a centralized processing server, and database where raw customer relationship management data may be uploaded and stored. The web server may contain an online web platform to present a button to upload customer relationship management files manually, or files may be sent automatically to the web server through automated processes. After customer relationship management files are received by the web server, the centralized processing server calculates opportunity records comprising business cohort, stage, staleness, time to event, and whether the event occurred, and stores these values in a database.

The centralized processing server further reads opportunity records from the database, inputs the opportunity records to a survival model, and applies the resulting survival model to opportunity records to create cumulative incidence curves and sales forecasts. Finally the centralized processing server sends this information back to the web server, where it can be viewed graphically by a user or output as a file or data stream to be read by another program.

Although the invention has been explained in relation to its preferred embodiment, it is to be understood that many other possible modifications and variations can be made without departing from the spirit and scope of the invention.

What is claimed is:

1. A method of producing comparisons of business cohort productivity, optimization of business sales processes, resource planning, and sales forecasting, the method comprising:
gathering business sales customer relationship data;
transforming and preparing the business sales customer relationship data to include time to event, whether the event occurred, and staleness when applicable;
performing an analysis of the business sales customer relationship data; and generating an output.

2. The method of claim 1, wherein the analysis of the business sales customer relationship data follows a statistical approach using survival analyses.

3. The method of producing comparisons of business cohort productivity, optimization of business sales processes, resource planning, and sales forecasting from claim 2, wherein:
a plurality of modeling parameters is defined for at least one modeling objective; and
when the business sales customer relationship data is transformed and prepared, the business sales customer relationship data is filtered based on the plurality of modeling parameters to create model training and evaluation data sets.

4. The method of producing comparisons of business cohort productivity, optimization of business sales processes, resource planning, and sales forecasting from claim 3, further comprising the generation of one or more survival models from the analyzed business sales customer relationship data and the plurality of modeling parameters.

5. The method of producing comparisons of business cohort productivity, optimization of business sales processes, resource planning, and sales forecasting from claim 4, wherein the plurality of modeling parameters comprise data variables that indicate current stage, staleness, business cohort, and other inputs.

6. The method of producing comparisons of business cohort productivity, optimization of business sales processes, resource planning, and sales forecasting from claim 5, wherein the methodology for fitting survival models comprises the Kaplan-Meier estimator, Cox proportional hazards, or other related statistical models on business cohort-, stage-, and staleness-stratified data.

7. The method of producing comparisons of business cohort productivity, optimization of business sales processes, resource planning, and sales forecasting from claim 6, wherein the output includes one or more cumulative incidence curves by business cohort, stage, and staleness, representing the probability over time of an open opportunity record event occurring.

8. The method of producing comparisons of business cohort productivity, optimization of business sales processes, resource planning, and sales forecasting from claim 6, wherein the output includes one or more cumulative incidence curves representing the probability over time of a new opportunity event occurring, further comprising a comparison across business cohorts.

9. The method of producing comparisons of business cohort productivity, optimization of business sales processes, resource planning, and sales forecasting from claim 7, wherein the output includes sales forecasts that are generated by combining one or more cumulative incidence curves based on an opportunity record's current state, wherein the current state includes stage, staleness, and business cohort for existing open opportunity records.

10. The method of producing comparisons of business cohort productivity, optimization of business sales processes, resource planning, and sales forecasting from claim 8, wherein the output further includes sales forecasts for all new opportunities by business cohort that are generated by combining one or more cumulative incidence curves with time-series models of new opportunity generation.

11. The method of producing comparisons of business cohort productivity, optimization of business sales processes, resource planning, and sales forecasting from claim 10, wherein:
the business sales customer relationship data includes a sales goal that is given for a fixed point in the future, along with a current sales stage; and
the output includes an estimated rate of new opportunity generation required to meet the desired sales goal.

12. The method of producing comparisons of business cohort productivity, optimization of business sales processes, resource planning, and sales forecasting from claim 11, further comprising:
solving for optimal business cohort combinations to meet desired sales objectives weighted by various specified constraints per business cohort.

13. A system in which a user performs the method of claim 1 by providing business sales customer relationship data and viewing the output through an online platform, comprising:
a front-end online platform consisting of at least one website, web application, desktop application, mobile application, or online interface;
a centralized server;
a plurality of network-connected user devices; and
at least one database.

14. The system of claim 13, wherein:
the at least one database includes a time-series database configured for receiving the business sales customer relationship data and optional additional related data sources; and
the centralized server runs manual batch processes or automated reporting processes on a regular schedule to obtain additional business sales customer relationship data.

15. The system of claim 14, wherein the plurality of modeling parameters is entered interactively.

16. The system of claim 15, wherein analyses defined by the plurality of modeling parameters are updated through an automated reporting process on a regular schedule.

17. The system of claim 16, wherein the output is readable by other applications directly through an application programming interface.
